(19) United States
(12) Patent Application Publication
(10) Pub. No.: US 2020/0068891 A1
(43) Pub. Date: Mar. 5, 2020

(54) Synergetic Biocidal Compositions Comprising 5-Chlorine-2-Methylisothiazolin-3-One

(71) Applicant: THOR GMBH, Speyer (DE)

(72) Inventors: Rudiger Baum, Neulussheim (DE); Thomas Wunder, Neustadt a.d. Weinstrasse (DE); Hans-Jurgen Schmidt, Speyer (DE); Peter Erich Hahn, Lampertheim (DE)

(73) Assignee: THOR GMBH, Speyer (DE)

(21) Appl. No.: 16/489,081

(22) PCT Filed: Feb. 23, 2018
(86) PCT No.: PCT/EP2018/000070

§ 371 Date: Aug. 27, 2019

(30) Foreign Application Priority Data
Feb. 28, 2017 (EP) 17000315.6

(51) Int. Cl. A01N 43/80; A01N 47/12; A01N 31/04; A01N 37/06; A01N 33/12; A01N 43/16; A01N 37/10; A01N 37/04; A01N 57/12; A01N 31/02; A01N 25/02

(52) U.S. Cl. CPC A01N 43/80; A01N 47/12; A01N 31/04; A01N 37/06; A01N 33/12; A01N 25/02; A01N 37/10; A01N 37/04; A01N 57/12; A01N 31/02; A01N 43/16

(57) ABSTRACT

The present invention relates to a biocidal composition, which contains 5-chloro-2-methylisothiazolin-3-one and at least one further component chosen from the group consisting of 3-iodo-2-propanyl butylcarbamate, octylisothiazolinone, n-butyl-benzisothiazolinone, phenetyl alcohol, methylparaben, ethylparaben, benzoic acid, sorbic acid, salicylic acid, dehydracetic acid, didecyldimethylammonium chloride, benzalkonium chloride, formaldehyde, glutaraldehyde, (1-hydroxyethylidene)bis-phosphonic acid, N,N-ethylenediamine disuccinate, and polyaspartic acid. The biocidal composition according to the invention is characterized in that it contains methyl-4-isothiazolin-3-one in the range of between 0 and 2 wt. %, in relation to the total amount of 5-chloro-2-methyl-4-isothiazolin-3-one. The invention further relates to the use of the biocidal compositions according to the invention for preserving technical products.

The present invention relates to a biocidal composition which contains 5-chloro-2-methylisothiazolin-3-one as well as at least one further component chosen from the group consisting of 3-iodo-2-propynyl butylcarbamate, octylisothiazolinone, N-butyl-benzisothiazolinone, phenetyl alcohol, methylparaben, ethylparaben, benzoic acid, sorbic acid, salicylic acid, dehydracetic acid, didecyldimethylammonium chloride, benzalkonium chloride, formaldehyde, glutardialdehyde, (1-hydroxyethylidene)bis-phosphonic acid, N,N-ethylenediamine disuccinate and polyaspartic acid. The biocidal composition according to the invention is characterized in that it contains methyl-4-isothiazolin-3-one in the range between 0 and 2 wt. %, in relation to the total amount of the 5-chloro-2-methyl-4-isothiazolin-3-one. The invention also relates to the use of the biocidal compositions according to the invention for preserving technical products.

Technical products, especially aqueous products, such as paints, varnishes, emulsions and cosmetic products, are typically produced by using natural or biodegradable raw materials. These raw materials and the water used as solvent are often laden with germs, such as bacteria, yeasts and fungi. If a preservation step is omitted during the production of these products, they may contain large germ counts even one day after production.

In order to make sure that these products meet the hygiene requirements, thereby ensuring the shelf life of the technical products, so-called biocides are added to the products. One of these biocides is 5-chloro-2-methylisothiazolin-3-one (CMIT). This has a broad biocidal effect, but also various drawbacks in its practical handling. For example, this compound may trigger allergies in the persons handling it.

In order to overcome the drawbacks of CMIT, which, although extremely effective, also has drawbacks for the end users, a search was undertaken in the 1990s for alternative biocides or biocidal compositions, the active ingredients of which interact synergistically and can be used in lesser concentrations when employed at the same time, as compared to the concentrations needed in the case of the individual components.

Thus, the synergetic mixture disclosed in EP 1 005 271 B1 of the isothiazolinones 2-methylisothiazolin-3-one (MIT) and 1,2-benzisothiazolin-3-one (BIT) has been used as a biocidal composition, since the early 1990s. This mixture is marketed by Thor GmbH (Speyer, Federal Republic of Germany) under the name Acticide MBS, it is free of 5-chloro-2-methylisothiazolin-3-one, and at present represents the standard for in-can preservation of water-based paints and plasters

Furthermore, the European laid-open application EP 0 676 140 discloses, for example, a synergetic biocidal composition which contains 2-methylisothiazolin-3-one and 2-n-octylisothiazolin-3-one as a replacement for 5-chloro-2-methylisothiazolin-3-one.

Likewise, EP-B 1 030 558 discloses a synergetic biocidal composition which contains 2-methylisothiazolin-3-ones and 3-iodo-2-propynyl-N-butylcarbamate. This synergetic composition is suitable for control of microorganisms even at low concentrations.

Starting from the above-discussed prior art, there is a demand for further biocidal compositions, the components of which interact synergistically and therefore can be used in lesser concentrations when employed together, as compared to the concentrations needed in the case of the individual components.

This problem is solved by the invention by means of a biocidal composition containing 5-chloro-2-methylisothiazolin-3-one and at least one further component selected from the group consisting of 3-iodo-2-propynyl butylcarbamate (IPBC), octylisothiazolinone (OIT), N-butyl-benzisothiazolinone (BBIT), phenetyl alcohol, methylparaben, ethylparaben, benzoic acid and/or salts thereof, sorbic acid and/or salts thereof, salicylic acid and/or salts thereof, dehydracetic acid and/or salts thereof, didecyldimethylammonium chloride (DDAC), benzalkonium chloride (BAC), formaldehyde, glutardialdehyde, (1-hydroxyethylidene)bis-phosphonic acid (HEDP), N,N-ethylenediamine disuccinate (EDDS) and polyaspartic acid (PASP). The biocidal composition according to the invention is characterized in that it contains methyl-4-isothiazolin-3-one in the range of 0 to 2 wt. %, in relation to the total amount of the 5-chloro-2-methyl-4-isothiazolin-3-one.

The biocidal composition according to the invention has the advantage that the 5-chloro-2-methylisothiazolin-3-one and the at least one component from the above-indicated group interact synergistically and therefore can be used in low concentrations when employed at the same time, as compared to low concentrations in the case of the individual components.

The present invention furthermore makes it possible, by using the extremely effective 5-chloro-2-methylisothiazolin-3-one, which is free or almost free of 2-methylisothiazolin-3-one, to preserve products and to treat them in a way prior to marketing so that 5-chloro-2-methylisothiazolin-3-one is no longer present in the end product so that the allergy risk to the end user posed by these products is significantly reduced.

The biocidal composition according to the invention is generally characterized in that it contains methyl-4-isothiazolin-3-one in the range of 0 to 2 wt. %, in relation to the total amount of 5-chloro-2-methyl-4-isothiazolin-3-one. According to one preferred embodiment of the invention, the biocidal composition is characterized in that it contains methyl-4-isothiazolin-3-one in the range of 0 to 1 wt. %, in relation to the total amount of 5-chloro-2-methyl-4-isothiazolin-3-one. According to one especially preferred embodiment, the biocidal composition is characterized in that it contains methyl-4-isothiazolin-3-one in the range of 0 to 0.5 wt. %, in relation to the total amount of 5-chloro-2-methyl-4-isothiazolin-3-one.

“At least one” means, in the context of the present invention, that the biocidal composition contains a single further component or compound, or several, i.e. two, three, four, five or more components or compounds from the particular group.

According to one preferred embodiment, the present invention relates to a biocidal composition which contains 5-chloro-2-methylisothiazolin-3-one and at least one further component. The biocidal composition is characterized in that it contains methyl-4-isothiazolin-3-one in the range of 0 to 2 wt. %, in relation to the total amount of 5-chloro-2-methyl-4-isothiazolin-3-one. The biocidal composition is furthermore characterized in that the weight ratio of 5-chloro-2-methylisothiazolin-3-one to 3-iodo-2-propynyl butylcarbamate lies in the range of 3:1 to 1:3,000,

in that the weight ratio of 5-chloro-2-methylisothiazolin-3-one to octylisothiazolinone lies in the range of 8:1 to 1:800,

in that the weight ratio of 5-chloro-2-methylisothiazolin-3-one to N-butyl-benzisothiazolinone lies in the range of 3:1 to 1:60,

in that the weight ratio of 5-chloro-2-methylisothiazolin-3-one to phenetyl alcohol lies in the range of 1:167 to 1:4,000,

in that the weight ratio of 5-chloro-2-methylisothiazolin-3-one to 2,2-methylparaben lies in the range of 1:125 to 1:750,

the weight ratio of 5-chloro-2-methylisothiazolin-3-one to ethylparaben lies in the range of 1:83 to 1:2,000,

in that the weight ratio of 5-chloro-2-methylisothiazolin-3-one to benzoic acid and/or salts thereof lies in the range of 1:167 to 1:2,000,

in that the weight ratio of 5-chloro-2-methylisothiazolin-3-one to sorbic acid and/or salts thereof lies in the range of 1:63 to 1:2,000,

in that the weight ratio of 5-chloro-2-methylisothiazolin-3-one to salicylic acid and/or salts thereof lies in the range of 1:63 to 1:4,000,

in that the weight ratio of 5-chloro-2-methylisothiazolin-3-one to dehydracetic acid and/or salts thereof lies in the range of 1:33 to 1:600,

in that the weight ratio of 5-chloro-2-methylisothiazolin-3-one to didecyldimethylammonium chloride lies in the range of 3:1 to 1:20,

in that the weight ratio of 5-chloro-2-methylisothiazolin-3-one to benzalkonium chloride lies in the range of 1:3 to 1:40,

in that the weight ratio of 5-chloro-2-methylisothiazolin-3-one to formaldehyde lies in the range of 1:10 to 1:1,000,

the weight ratio of 5-chloro-2-methylisothiazolin-3-one to glutardialdehyde lies in the range of 1:21 to 1:500,

in that the weight ratio of 5-chloro-2-methylisothiazolin-3-one to (1-hydroxyethylidene)bis-phosphonic acid lies in the range of 1:11 to 1:500,

in that the weight ratio of 5-chloro-2-methylisothiazolin-3-one to ethylenediamine disuccinate lies in the range of 1:104 to 1:10,000, or

in that the weight ratio of 5-chloro-2-methylisothiazolin-3-one to polyaspartic acid (as Na salt) lies in the range of 1:208 to 1:6.667.

Synergetic Biocidal Composition Containing 5-chloro-2-methylisothiazolin-3-one and 3-iodo-2-propynyl butylcarbamate (IPBC):

According to one embodiment, the invention relates to a biocidal composition containing 5-chloro-2-methylisothiazolin-3-one and 3-iodo-2-propynyl butylcarbamate (IPBC). The biocidal composition according to the invention is characterized in that it contains methyl-4-isothiazolin-3-one in the range of 0 to 2 wt. %, in relation to the total amount of the 5-chloro-2-methyl-4-isothiazolin-3-one.

According to one preferred embodiment, the invention relates to a biocidal composition containing 5-chloro-2-methylisothiazolin-3-one and 3-iodo-2-propynyl butylcarbamate, in a weight ratio of 5-chloro-2-methylisothiazolin-3-one to 3-iodo-2-propynyl butylcarbamate generally in the range of 3:1 to 1:3,000, preferably in the range of 2:1 to 1:1,500, especially preferably in the range of 1:1 to 1:1,000. The biocidal composition according to the invention is characterized in that it contains methyl-4-isothiazolin-3-one in the range of 0 to 2 wt. %, in relation to the total amount of the 5-chloro-2-methyl-4-isothiazolin-3-one.

Synergetic Biocidal Composition Containing 5-chloro-2-methylisothiazolin-3-one and octylisothiazolinone (OIT):

According to one embodiment the invention relates to a biocidal composition containing 5-chloro-2-methylisothiazolin-3-one and octylisothiazolinone (OIT). The biocidal composition according to the invention is characterized in that it contains methyl-4-isothiazolin-3-one in the range of 0 to 2 wt. %, in relation to the total amount of the 5-chloro-2-methyl-4-isothiazolin-3-one.

According to a preferred embodiment the invention relates to a biocidal composition containing 5-chloro-2-methylisothiazolin-3-one and octylisothiazolinone, in a weight ratio of 5-chloro-2-methylisothiazolin-3-one to octylisothiazolinone generally in the range of 8:1 to 1:800, preferably in the range of 4:1 to 1:400, especially preferably in the range of 1:1 to 1:200. The biocidal composition according to the invention is characterized in that it contains methyl-4-isothiazolin-3-one in the range of 0 to 2 wt. %, in relation to the total amount of the 5-chloro-2-methyl-4-isothiazolin-3-one.

Synergetic Biocidal Composition Containing 5-chloro-2-methylisothiazolin-3-one and N-butyl-benzisothiazolinone (BBIT):

According to one embodiment the invention relates to a biocidal composition containing 5-chloro-2-methylisothiazolin-3-one and N-butyl-benzisothiazolinone (BBIT). The biocidal composition according to the invention is characterized in that it contains methyl-4-isothiazolin-3-one in the range of 0 to 2 wt. %, in relation to the total amount of the 5-chloro-2-methyl-4-isothiazolin-3-one.

According to a preferred embodiment the invention relates to a biocidal composition containing 5-chloro-2-methylisothiazolin-3-one and N-butyl-benzisothiazolinone, in a weight ratio of 5-chloro-2-methylisothiazolin-3-one to N-butyl-benzisothiazolinone generally in the range of 3:1 to 1:60, preferably in the range of 2:1 to 1:50, especially preferably in the range of 1:1 to 1:40. The biocidal composition according to the invention is characterized in that it contains methyl-4-isothiazolin-3-one in the range of 0 to 2 wt. %, in relation to the total amount of the 5-chloro-2-methyl-4-isothiazolin-3-one.

Synergetic Biocidal Composition Containing 5-chloro-2-methylisothiazolin-3-one and Phenetyl Alcohol:

According to one embodiment the invention relates to a biocidal composition containing 5-chloro-2-methylisothiazolin-3-one and phenetyl alcohol. The biocidal composition according to the invention is characterized in that it contains methyl-4-isothiazolin-3-one in the range of 0 to 2 wt. %, in relation to the total amount of the 5-chloro-2-methyl-4-isothiazolin-3-one.

According to a preferred embodiment the invention relates to a biocidal composition containing 5-chloro-2-methylisothiazolin-3-one and phenetyl alcohol in a weight ratio of 5-chloro-2-methylisothiazolin-3-one to phenetyl alcohol generally in the range of 1:167 to 1:4,000, preferably in the range of 1:100 to 1:2,000, especially preferably in the range of 1:50 to 1:1,000. The biocidal composition according to the invention is characterized in that it contains methyl-4-isothiazolin-3-one in the range of 0 to 2 wt. %, in relation to the total amount of the 5-chloro-2-methyl-4-isothiazolin-3-one.

Synergetic Biocidal Composition Containing 5-chloro-2-methylisothiazolin-3-one and 2,2-methylparaben:

According to one embodiment the invention relates to a biocidal composition containing 5-chloro-2-methylisothiazolin-3-one and 2,2-methylparaben. The biocidal composition according to the invention is characterized in that it contains methyl-4-isothiazolin-3-one in the range of 0 to 2 wt. %, in relation to the total amount of the 5-chloro-2-methyl-4-isothiazolin-3-one.

According to a preferred embodiment the invention relates to a biocidal composition containing 5-chloro-2-methylisothiazolin-3-one and 2,2-methylparaben in a weight ratio of 5-chloro-2-methylisothiazolin-3-one to 2,2-methylparaben generally in the range of 1:125 to 1:750, preferably in the range of 1:100 to 1:500, especially preferably in the range of 1:50 to 1:400. The biocidal composition according to the invention is characterized in that it contains methyl-4-isothiazolin-3-one in the range of 0 to 2 wt. %, in relation to the total amount of the 5-chloro-2-methyl-4-isothiazolin-3-one.

Synergetic Biocidal Composition Containing 5-chloro-2-methylisothiazolin-3-one and ethylparaben:

According to one embodiment the invention relates to a biocidal composition containing 5-chloro-2-methylisothiazolin-3-one and ethylparaben. The biocidal composition according to the invention is characterized in that it contains methyl-4-isothiazolin-3-one in the range of 0 to 2 wt. %, in relation to the total amount of the 5-chloro-2-methyl-4-isothiazolin-3-one.

According to a preferred embodiment the invention relates to a biocidal composition containing 5-chloro-2-methylisothiazolin-3-one and ethylparaben in a weight ratio of 5-chloro-2-methylisothiazolin-3-one to ethylparaben generally in the range of 1:83 to 1:2,000, preferably in the range of 1:50 to 1:1,000, especially preferably in the range of 1:40 to 1:500. The biocidal composition according to the invention is characterized in that it contains methyl-4-isothiazolin-3-one in the range of 0 to 2 wt. %, in relation to the total amount of the 5-chloro-2-methyl-4-isothiazolin-3-one.

Synergetic Biocidal Composition Containing 5-chloro-2-methylisothiazolin-3-one and Benzoic Acid or Salts Thereof:

According to one embodiment the invention relates to a biocidal composition containing 5-chloro-2-methylisothiazolin-3-one and benzoic acid. The biocidal composition according to the invention is characterized in that it contains methyl-4-isothiazolin-3-one in the range of 0 to 2 wt. %, in relation to the total amount of the 5-chloro-2-methyl-4-isothiazolin-3-one.

According to a preferred embodiment the invention relates to a biocidal composition containing 5-chloro-2-methylisothiazolin-3-one and benzoic acid in a weight ratio of 5-chloro-2-methylisothiazolin-3-one to benzoic acid generally in the range of 1:167 to 1:2,000, preferably in the range of 1:150 to 1:1,000, especially preferably in the range of 1:100 to 1:500. The biocidal composition according to the invention is characterized in that it contains methyl-4-isothiazolin-3-one in the range of 0 to 2 wt. %, in relation to the total amount of the 5-chloro-2-methyl-4-isothiazolin-3-one.

Synergetic Biocidal Composition Containing 5-chloro-2-methylisothiazolin-3-one and Sorbic Acid or Salts Thereof:

According to one embodiment the invention relates to a biocidal composition containing 5-chloro-2-methylisothiazolin-3-one and sorbic acid. The biocidal composition according to the invention is characterized in that it contains methyl-4-isothiazolin-3-one in the range of 0 to 2 wt. %, in relation to the total amount of the 5-chloro-2-methyl-4-isothiazolin-3-one.

According to a preferred embodiment the invention relates to a biocidal composition containing 5-chloro-2-methylisothiazolin-3-one and sorbic acid in a weight ratio of 5-chloro-2-methylisothiazolin-3-one to sorbic acid generally in the range of 1:63 to 1:2,000, preferably in the range of 1:50 to 1:1,500, especially preferably in the range of 1:10 to 1:1,000. The biocidal composition according to the invention is characterized in that it contains methyl-4-isothiazolin-3-one in the range of 0 to 2 wt. %, in relation to the total amount of the 5-chloro-2-methyl-4-isothiazolin-3-one.

Synergetic Biocidal Composition Containing 5-chloro-2-methylisothiazolin-3-one and Salicylic Acid or Salts Thereof:

According to one embodiment the invention relates to a biocidal composition containing 5-chloro-2-methylisothiazolin-3-one and salicylic acid. The biocidal composition according to the invention is characterized in that it contains methyl-4-isothiazolin-3-one in the range of 0 to 2 wt. %, in relation to the total amount of the 5-chloro-2-methyl-4-isothiazolin-3-one.

According to a preferred embodiment the invention relates to a biocidal composition containing 5-chloro-2-methylisothiazolin-3-one and salicylic acid in a weight ratio of 5-chloro-2-methylisothiazolin-3-one to salicylic acid generally in the range of 1:63 to 1:4,000, preferably in the range of 1:50 to 1:2,000, especially preferably in the range of 1:25 to 1:1,000. The biocidal composition according to the invention is characterized in that it contains methyl-4-isothiazolin-3-one in the range of 0 to 2 wt. %, in relation to the total amount of the 5-chloro-2-methyl-4-isothiazolin-3-one.

Synergetic Biocidal Composition Containing 5-chloro-2-methylisothiazolin-3-one and Dehydracetic Acid or Salts Thereof:

According to one embodiment the invention relates to a biocidal composition containing 5-chloro-2-methylisothiazolin-3-one and dehydracetic acid. The biocidal composition according to the invention is characterized in that it contains methyl-4-isothiazolin-3-one in the range of 0 to 2 wt. %, in relation to the total amount of the 5-chloro-2-methyl-4-isothiazolin-3-one.

According to a preferred embodiment the invention relates to a biocidal composition containing 5-chloro-2-methylisothiazolin-3-one and dehydracetic acid in a weight ratio of 5-chloro-2-methylisothiazolin-3-one to dehydracetic acid generally in the range of 1:33 to 1:600 and preferably in the range of 1:20 to 1:300. The biocidal composition according to the invention is characterized in that it contains methyl-4-isothiazolin-3-one in the range of 0 to 2 wt. %, in relation to the total amount of the 5-chloro-2-methyl-4-isothiazolin-3-one.

Synergetic Biocidal Composition Containing 5-chloro-2-methylisothiazolin-3-one and Didecyldimethylammonium Chloride:

According to one embodiment the invention relates to a biocidal composition containing 5-chloro-2-methylisothiazolin-3-one and didecyldimethylammonium chloride. The biocidal composition according to the invention is characterized in that it contains methyl-4-isothiazolin-3-one in the range of 0 to 2 wt. %, in relation to the total amount of the 5-chloro-2-methyl-4-isothiazolin-3-one.

According to a preferred embodiment the invention relates to a biocidal composition containing 5-chloro-2-methylisothiazolin-3-one and didecyldimethylammonium chloride in a weight ratio of 5-chloro-2-methylisothiazolin-3-one to didecyldimethylammonium chloride generally in the range of 3:1 to 1:20, preferably in the range of 1:1 to 1:20. The biocidal composition according to the invention is characterized in that it contains methyl-4-isothiazolin-3-one in the range of 0 to 2 wt. %, in relation to the total amount of the 5-chloro-2-methyl-4-isothiazolin-3-one.

Synergetic Biocidal Composition Containing 5-chloro-2-methylisothiazolin-3-one and Benzalkonium Chloride:

According to one embodiment the invention relates to a biocidal composition containing 5-chloro-2-methylisothiazolin-3-one and benzalkonium chloride. The biocidal composition according to the invention is characterized in that it contains methyl-4-isothiazolin-3-one in the range of 0 to 2 wt. %, in relation to the total amount of the 5-chloro-2-methyl-4-isothiazolin-3-one.

According to a preferred embodiment the invention relates to a biocidal composition containing 5-chloro-2-methylisothiazolin-3-one and benzalkonium chloride in a weight ratio of 5-chloro-2-methylisothiazolin-3-one to benzalkonium chloride generally in the range of 1:3 to 1:40, preferably in the range of 1:10 to 1:20. The biocidal composition according to the invention is characterized in that it contains methyl-4-isothiazolin-3-one in the range of 0 to 2 wt. %, in relation to the total amount of the 5-chloro-2-methyl-4-isothiazolin-3-one.

Synergetic Biocidal Composition Containing 5-chloro-2-methylisothiazolin-3-one and Formaldehyde:

According to one embodiment the invention relates to a biocidal composition containing 5-chloro-2-methylisothiazolin-3-one and formaldehyde. The biocidal composition according to the invention is characterized in that it contains methyl-4-isothiazolin-3-one in the range of 0 to 2 wt. %, in relation to the total amount of the 5-chloro-2-methyl-4-isothiazolin-3-one.

According to a preferred embodiment the invention relates to a biocidal composition containing 5-chloro-2-methylisothiazolin-3-one and formaldehyde in a weight ratio of 5-chloro-2-methylisothiazolin-3-one to formaldehyde generally in the range of 1:10 to 1:1,000, preferably in the range of 1:5 to 1:500. The biocidal composition according to the invention is characterized in that it contains methyl-4-isothiazolin-3-one in the range of 0 to 2 wt. %, in relation to the total amount of the 5-chloro-2-methyl-4-isothiazolin-3-one.

Synergetic Biocidal Composition Containing 5-chloro-2-methylisothiazolin-3-one and Glutardialdehyde:

According to one embodiment the invention relates to a biocidal composition containing 5-chloro-2-methylisothiazolin-3-one and glutardialdehyde. The biocidal composition according to the invention is characterized in that it contains methyl-4-isothiazolin-3-one in the range of 0 to 2 wt. %, in relation to the total amount of the 5-chloro-2-methyl-4-isothiazolin-3-one.

According to a preferred embodiment the invention relates to a biocidal composition containing 5-chloro-2-methylisothiazolin-3-one and glutardialdehyde in a weight ratio of 5-chloro-2-methylisothiazolin-3-one to glutardialdehyde generally in the range of 1:21 to 1:500, preferably in the range of 1:10 to 1:250. The biocidal composition according to the invention is characterized in that it contains methyl-4-isothiazolin-3-one in the range of 0 to 2 wt. %, in relation to the total amount of the 5-chloro-2-methyl-4-isothiazolin-3-one.

Synergetic Biocidal Composition Containing 5-chloro-2-methylisothiazolin-3-one and (1-hydroxyethylidene)bis-phosphonic acid:

According to one embodiment the invention relates to a biocidal composition containing 5-chloro-2-methylisothiazolin-3-one and (1-hydroxyethylidene)bis-phosphonic acid. The biocidal composition according to the invention is characterized in that it contains methyl-4-isothiazolin-3-one in the range of 0 to 2 wt. %, in relation to the total amount of the 5-chloro-2-methyl-4-isothiazolin-3-one.

According to a preferred embodiment the invention relates to a biocidal composition containing 5-chloro-2-methylisothiazolin-3-one and (1-hydroxyethylidene)bis-phosphonic acid in a weight ratio of 5-chloro-2-methylisothiazolin-3-one to (1-hydroxyethylidene)bis-phosphonic acid generally in the range of 1:11 to 1:500, preferably in the range of 1:5 to 1:250. The biocidal composition according to the invention is characterized in that it contains methyl-4-isothiazolin-3-one in the range of 0 to 2 wt. %, in relation to the total amount of the 5-chloro-2-methyl-4-isothiazolin-3-one.

Synergetic Biocidal Composition Containing 5-chloro-2-methylisothiazolin-3-one and Ethylenediamine Disuccinate:

According to one embodiment the invention relates to a biocidal composition containing 5-chloro-2-methylisothiazolin-3-one and ethylenediamine disuccinate. The biocidal composition according to the invention is characterized in that it contains methyl-4-isothiazolin-3-one in the range of 0 to 2 wt. %, in relation to the total amount of the 5-chloro-2-methyl-4-isothiazolin-3-one.

According to a preferred embodiment the invention relates to a biocidal composition containing 5-chloro-2-methylisothiazolin-3-one and ethylenediamine disuccinate in a weight ratio of 5-chloro-2-methylisothiazolin-3-one to ethylenediamine disuccinate generally in the range of 1:104 to 1:10,000, preferably in the range of 1:50 to 1:5,000. The biocidal composition according to the invention is characterized in that it contains methyl-4-isothiazolin-3-one in the range of 0 to 2 wt. %, in relation to the total amount of the 5-chloro-2-methyl-4-isothiazolin-3-one.

Synergetic Biocidal Composition Containing 5-chloro-2-methylisothiazolin-3-one and Polyaspartic Acid:

According to one embodiment the invention relates to a biocidal composition containing 5-chloro-2-methylisothiazolin-3-one and polyaspartic acid. The biocidal composition according to the invention is characterized in that it contains methyl-4-isothiazolin-3-one in the range of 0 to 2 wt. %, in relation to the total amount of the 5-chloro-2-methyl-4-isothiazolin-3-one.

According to a preferred embodiment the invention relates to a biocidal composition containing 5-chloro-2-methylisothiazolin-3-one and polyaspartic acid in a weight ratio of 5-chloro-2-methylisothiazolin-3-one to polyaspartic acid (as Na salt) generally in the range of 1:208 to 1:6,667, preferably in the range of 1:100 to 1:3,000. The biocidal composition according to the invention is characterized in that it contains methyl-4-isothiazolin-3-one in the range of 0 to 2 wt. %, in relation to the total amount of the 5-chloro-2-methyl-4-isothiazolin-3-one.

A biocidal composition containing exclusively 5-chloro-2-methylisothiazolin-3-one with a content of methyl-4-isothiazolin-3-one in the range of 0 to 2 wt. %, in relation to the total amount of the 5-chloro-2-methyl-4-isothiazolin-3-one, and at least one further component, chosen from the group consisting of 3-iodo-2-propynyl butylcarbamate, octylisothiazolinone, N-butyl-benzisothiazolinone, phenetyl alcohol, methylparaben, ethylparaben, benzoic acid, sorbic acid, salicylic acid, dehydracetic acid, didecyldimethylammonium chloride, benzalkonium chloride, formaldehyde, glutardialdehyde, (1-hydroxyethylidene)bis-phosphonic acid, ethylenediamine disuccinate and polyaspartic acid, in each case in the specified weight ratios, without the presence of a further component will be referred to within the scope of the present invention as a “biocidal composition according to the invention”.

A “biocidal composition according to the invention” can comprise, besides the 5-chloro-2-methylisothiazolin-3-one with a content of methyl-4-isothiazolin-3-one in the range of 0 to 2 wt. %, in relation to the total amount of the 5-chloro-2-methyl-4-isothiazolin-3-one, and the at least one further component, chosen from the group consisting of 3-iodo-2-propynyl butylcarbamate, octylisothiazolinone, N-butyl-benzisothiazolinone, phenetyl alcohol, methylparaben, ethylparaben, benzoic acid, sorbic acid, salicylic acid, dehydracetic acid, didecyldimethylammonium chloride, benzalkonium chloride, formaldehyde, glutardialdehyde, (1-hydroxyethylidene)bis-phosphonic acid, ethylenediamine disuccinate and polyaspartic acid, additionally one or more further constituents. The further constituent(s) can have a microbiocidal effect or might have no microbiocidal effect, that is to say for example may be a solvent, dispersant or suspending agent.

It is advantageous if the biocidal composition according to the invention contains the 5-chloro-2-methylisothiazolin-3-one with a content of methyl-4-isothiazolin-3-one in the range of 0 to 2 wt. %, in relation to the total amount of the 5-chloro-2-methyl-4-isothiazolin-3-one, and at least one further component, chosen from the group of 3-iodo-2-propynyl butylcarbamate, octylisothiazolinone, N-butyl-benzisothiazolinone, phenetyl alcohol, methylparaben, ethylparaben, benzoic acid, sorbic acid, salicylic acid, dehydracetic acid, didecyldimethylammonium chloride, benzalkonium chloride, formaldehyde, glutardialdehyde, (1-hydroxyethylidene)bis-phosphonic acid, ethylenediamine disuccinate and polyaspartic acid, in a total concentration of 0.5 to 50 wt. %, preferably of 1 to 20 wt. %, especially preferably of 2.5 to 10 wt. %, in each case in relation to the total biocidal composition.

In a further embodiment the biocidal composition according to the invention consists predominantly of 5-chloro-2-methylisothiazolin-3-one with a content of methyl-4-isothiazolin-3-one in the range of 0 to 2 wt. %, in relation to the total amount of the 5-chloro-2-methyl-4-isothiazolin-3-one, and at least one further component, chosen from the group consisting of 3-iodo-2-propynyl butylcarbamate, octylisothiazolinone, N-butyl-benzisothiazolinone, phenetyl alcohol, methylparaben, ethylparaben, benzoic acid or salts thereof, sorbic acid or salts thereof, salicylic acid or salts thereof, dehydracetic acid or salts thereof, didecyldimethylammonium chloride, benzalkonium chloride, formaldehyde, glutardialdehyde, (1-hydroxyethylidene)bis-phosphonic acid, ethylenediamine disuccinate and polyaspartic acid (that is to say the biocidal composition according to the invention or the biocidal mixture). This means that the biocidal composition according to the invention contains the biocidal mixture as main constituent, preferably in an amount equal to or greater than 50 wt. %, more preferably in an amount equal to or greater than 70 wt. %, in particular in an amount equal to or greater than 90 wt. %, in particular in an amount equal to or greater than 95 wt. %, in relation to the total mass of biocidal active substance. In addition, at least one further biocidal can be provided, as well as one or more solvents, dispersants or suspending agents.

In accordance with a further embodiment of the invention the biocidal composition according to the invention consists substantially of the biocidal mixture according to the invention, i.e. besides the mixture there may also be contained one or more other biocides, but these are present in such amounts that there is no contribution of the particular biocide(s) different from the components of the mixture to the overall effect of the resulting mixture. Thus, if the biocidal effect of a biocidal composition according to the invention comprising—besides the components of the biocidal mixture according to the invention as principal ingredient—also one or more other biocides in subordinate or lesser concentration is not changed as compared to the use of the biocidal mixture according to the invention, this is termed as “consisting substantially” in the context of the present invention. One or more other constituents without a biocidal effect may be present, such as solvents.

In another embodiment, the biocidal composition according to the invention may consist of the components of the biocidal mixture according to the invention as the sole biocidal active substances, i.e. an active substance content of 100% 5-chloro-2-methylisothiazolin-3-one with a content of methyl-4-isothiazolin-3-one in the range of 0 to 2 wt. %, in relation to the total proportion of 5-chloro-2-methyl-4-isothiazolin-3-one, and at least one further component, chosen from the group consisting of 3-iodo-2-propynyl butylcarbamate, octylisothiazolinone, N-butyl-benzisothiazolinone, phenetyl alcohol, methylparaben, ethylparaben, benzoic acid, sorbic acid, salicylic acid, dehydracetic acid, didecyldimethylammonium chloride, benzalkonium chloride, formaldehyde, glutardialdehyde, (1-hydroxyethylidene)bis-phosphonic acid, ethylenediamine disuccinate and polyaspartic acid. In such a case, it is only possible for one or more further constituents with no biocidal effect to be present, such as solvents or stabilisers.

According to one embodiment of the invention the biocidal composition according to the invention is present as a concentrate, which is added to the substances or products being preserved with it. The concentrate advantageously comprises 5-chloro-2-methylisothiazolin-3-one in a quantity of 0.5 to 50 wt. %, preferably in a quantity of 0.5 to 20 wt. %, especially preferably in a quantity of 0.7 to 10 wt. %, in relation to the total mass of the concentrate. The quantity of the at least one further component selected from the group of 3-iodo-2-propynyl butylcarbamate, octylisothiazolinone, N-butyl-benzisothiazolinone, phenetyl alcohol, methylparaben, ethylparaben, benzoic acid, sorbic acid, salicylic acid, dehydracetic acid, didecyldimethylammonium chloride, benzalkonium chloride, formaldehyde, glutardialdehyde, (1-hydroxyethylidene)bis-phosphonic acid, ethylenediamine disuccinate and polyaspartic acid contained in the concentrate generally amounts to 0.5 to 50 wt. %, preferably 1 to 20 wt. %, especially preferably 1 to 5 wt. %, in relation to the total mass of the concentrate.

In an advantageous embodiment the biocidal composition is present in the form of a liquid preparation, for example as a solution, a suspension or a dispersion in a liquid medium. Of course, the biocidal composition according to the invention may also be mixed directly in a product being preserved. This is done by adding the individual microbicidally active components to the product being preserved.

It is expedient for the biocidal composition according to the invention to be present for application in combination with a polar or nonpolar liquid medium.

Preferred polar liquid media are water, aliphatic alcohols with 1 to 4 carbon atoms, such as ethanol and isopropanol, a glycol, such as ethylene glycol, diethylene glycol, 1,2-propylene glycol, dipropylene glycol and tripropylene glycol, a glycol ether, such as butylglycol and butyldiglycol, a glycol ester, such as butylglycol acetate or 2,2,4-trimethylpentane diol monoisobutyrate, a polyethylene glycol, a propylene glycol, N,N-dimethylformamide, or a mixture of two or more of such media. The polar liquid medium is in particular water and/or glycol.

For example, aromatics may be used as nonpolar liquid media, preferably xylene and toluene. These may also be used alone or as mixtures of two or more such media.

The biocidal composition according to the invention may be also combined at the same time with a polar or a nonpolar liquid medium.

It is generally possible to adapt the biocidal composition according to the invention to special areas of application by adding further active substances, for example in the sense of a heightened effect or improved compatibility with the substances being protected against microorganisms. These further substances are known to the person skilled in the field of biocides and may be chosen by them depending on the application for the biocidal composition according to the invention.

The biocidal composition according to the invention may be used for preservation in many diverse fields. Preferably, the preparation according to the invention is used for in-can preservation, especially preferably for the preservation of coating materials such as paints, varnishes and plaster, of polymer dispersions, emulsions, slurries, pigment preparations, laundry detergents and cleaning products, and adhesives.

The invention furthermore also relates to products which contain the biocidal composition according to the invention. These products are generally chosen from lignin sulfonates and starch preparations in coating materials, paints, varnishes, glazes and plasters, emulsions, latexes, polymer dispersions, chalk slurries, mineral slurries, ceramic materials, adhesives, fragrances, casein-containing products, starch-containing products, bitumen emulsions, surfactant solutions, fuels, cleaning agents, pigment pastes and pigment dispersions, inks, lithographic liquids, thickeners, cosmetic products, toilet articles, water systems, fluids in wood working, fluids in oil extraction, fluids in paper processing, fluids in leather production, fluids in textile production, drilling and cutting oils, hydraulic fluids and cooling lubricants.

In the practical application, the biocidal composition may be applied either as a ready-to-use mixture or by separate adding of the individual components of the composition to the product being preserved.

The content of the components in the preservation application (the application concentration) may vary in a broad range depending on the purpose of the application and is usually determined by the person skilled in the field of biocides. The following indicated concentration ranges will provide the skilled person with an indication of the concentrations to be used.

In the product preserved using the composition according to the invention the at least one component is chosen from the group consisting of 3-iodo-2-propynyl butylcarbamate, octylisothiazolinone, N-butyl-benzisothiazolinone, phenetyl alcohol, methylparaben, ethylparaben, benzoic acid, sorbic acid, salicylic acid, dehydracetic acid, didecyldimethylammonium chloride, benzalkonium chloride, formaldehyde, glutardialdehyde, (1-hydroxyethylidene)bis-phosphonic acid, ethylenediamine disuccinate and polyaspartic acid.

The content of the components in the preservation application (the application concentration) may vary in a broad range depending on the purpose of the application and is usually established by the person skilled in the field of biocides. The following indicated concentration ranges will provide the skilled person with an indication of the concentrations to be used.

In the product preserved with the biocidal composition according to the invention, the chloro-2-methylisothiazolin-3-one is contained generally in a quantity in the range of 1 to 500 ppm, preferably in a quantity of 5 to 200 ppm, especially preferably in a quantity of 10 to 100 ppm, in particular preferably in a quantity of 10 to 30 ppm.

In the product preserved using the composition according to the invention the at least one further component is chosen from the group consisting of 3-iodo-2-propynyl butylcarbamate, octylisothiazolinone, N-butyl-benzisothiazolinone, phenetyl alcohol, methylparaben, ethylparaben, benzoic acid, sorbic acid, salicylic acid, dehydracetic acid, didecyldimethylammonium chloride, benzalkonium chloride, formaldehyde, glutardialdehyde, (1-hydroxyethylidene)bis-phosphonic acid, ethylenediamine disuccinate and polyaspartic acid.

In the presence of 3-iodo-2-propynyl butylcarbamate as further component, this is contained in the product preserved using the composition according to the invention generally in an amount in the range of 1 to 7500 ppm, especially preferably in an amount of 10 to 5000 ppm, preferably in an amount of 25 to 2500 ppm, in particular preferably in an amount of 50 to 1000 ppm.

In the presence of octylisothiazolinone as further component, this is contained in the product preserved using the composition according to the invention generally in an amount in the range of 1 to 3000 ppm, preferably in an amount of 5 to 1500 ppm, especially preferably in an amount of 10 to 1000 ppm, in particular preferably in an amount of 25 to 500 ppm.

In the presence of N-butyl-benzisothiazolinone as further component, this is contained in the product preserved using the composition according to the invention generally in an amount in the range of 1 to 3000 ppm, preferably in an amount of 5 to 1500 ppm, especially preferably in an amount of 10 to 1000 ppm, in particular preferably in an amount of 25 to 500 ppm.

In the presence of phenetyl alcohol as further component, this is contained in the product preserved using the composition according to the invention generally in an amount in the range of 1 to 20000 ppm, preferably in an amount of 50 to 15000 ppm, especially preferably in an amount of 100 to 12500 ppm, in particular preferably in an amount of 500 to 10000 ppm.

In the presence of methylparaben as further component, this is contained in the product preserved using the composition according to the invention generally in an amount in the range of 1 to 10000 ppm, preferably in an amount of 25 to 7500 ppm, in particular preferably in an amount of 50 to 5000 ppm.

In the presence of ethylparaben as further component, this is contained in the product preserved using the composition according to the invention generally in an amount in the range of 1 to 10000 ppm, preferably in an amount of 25 to 7500 ppm, in particular preferably in an amount of 50 to 5000 ppm.

In the presence of benzoic acid or salts thereof as further component, this is contained in the product preserved using the composition according to the invention generally in an amount in the range of 1 to 10000 ppm, preferably in an amount of 10 to 7500 ppm, in particular preferably in an amount of 50 to 5000 ppm.

In the presence of sorbic acid or salts thereof as further component, this is contained in the product preserved using the composition according to the invention generally in an amount in the range of 1 to 10000 ppm, preferably in an amount of 10 to 7500 ppm, in particular preferably in an amount of 50 to 5000 ppm.

In the presence of salicylic acid or salts thereof as further component, this is contained in the product preserved using the composition according to the invention generally in an amount in the range of 1 to 10000 ppm, preferably in an amount of 10 to 7500 ppm, in particular preferably in an amount of 50 to 5000 ppm.

In the presence of dehydracetic acid or salts thereof as further component, this is contained in the product preserved using the composition according to the invention generally in an amount in the range of 1 to 10000 ppm, preferably in an amount of 10 to 7500 ppm, in particular preferably in an amount of 50 to 5000 ppm.

In the presence of didecyldimethylammonium chloride as further component, this is contained in the product preserved using the composition according to the invention generally in an amount in the range of 1 to 2000 ppm, preferably in an amount of 5 to 1000 ppm, in particular preferably in an amount of 10 to 750 ppm.

In the presence of benzalkonium chloride as further component, this is contained in the product preserved using the composition according to the invention generally in an amount in the range of 1 to 4000 ppm, preferably in an amount of 5 to 2000 ppm, in particular preferably in an amount of 10 to 1000 ppm.

In the presence of formaldehyde as further component, this is contained in the product preserved using the composition according to the invention generally in an amount in the range of 1 to 1000 ppm, preferably in an amount of 10 to 750 ppm, especially preferably in an amount of 25 to 500 ppm, in particular preferably in an amount of 50 to 250 ppm.

In the presence of glutardialdehyde as further component, this is contained in the product preserved using the composition according to the invention generally in an amount in the range of 1 to 1000 ppm, preferably in an amount of 10 to 750 ppm, preferably in an amount of 25 to 500 ppm, in particular preferably in an amount of 50 to 250 ppm.

In the presence of (1-hydroxyethylidene) bis-phosphonic acid as further component, this is contained in the product preserved using the composition according to the invention generally in an amount in the range of 1 to 20000 ppm, preferably in an amount of 50 to 15000 ppm, in particular preferably in an amount of 100 to 10000 ppm.

In the presence of ethylenediamine disuccinate as further component, this is contained in the product preserved using the composition according to the invention generally in an amount in the range of 1 to 20000 ppm, preferably in an amount of 50 to 15000 ppm, in particular preferably in an amount of 100 to 10000 ppm.

In the presence of polyaspartic acid as further component, this is contained in the product preserved using the composition according to the invention generally in an amount in the range of 1 to 20000 ppm, preferably in an amount of 50 to 15000 ppm, in particular preferably in an amount of 100 to 10000 ppm.

### THE FOLLOWING EXAMPLES SERVE TO FURTHER EXPLAIN THE PRESENT INVENTION

### Examination of the Synergetic Effect

The synergism of a combination of 5-chloro-2-methylisothiazolin-3-one, containing 0.003 wt. %, in relation to the total amount of 5-chloro-2-methyl-4-isothiazolin-3-one, of 2-methylisothiazolin-3-one, with a biocide/a compound selected from the group consisting of 3-iodo-2-propynyl butylcarbamate (IPBC), octylisothiazolinone (OIT), N-butyl-benzisothiazolinone, phenetyl alcohol, methylparaben, ethylparaben, benzoic acid, sorbic acid, salicylic acid, dehydracetic acid, didecyldimethylammonium chloride (DDAC), benzalkonium chloride (BAC), formaldehyde, glutardialdehyde, (1-hydroxyethylidene)bis-phosphonic acid (HEDP), ethylenediamine disuccinate (EDDS) and polyaspartic acid (PASP), was investigated for a synergetic interaction.

The test organisms used were the Gram-negative bacterium Pseudomonas putida (DSM 25068) and the yeast fungus Yarrowia lipolytica (DSM 32369). For this, mixtures with different concentrations of the particular active substances were prepared and tested in regard to their effect on Pseudomonas putida and Yarrowia lipolytica. The testing was done in Milller-Hinton broth MHB (in the case of Pseudomonas) or Sabouraud Maltose broth SMB (in the case of Yarrowia) with a cell density of 10⁶ germs per ml.

The incubation time of the microtiter plates was 48 hours at 30° C. (Pseudomonas) or 25° C. (Yarrowia). After 48 hours the batches were evaluated for turbidity due to growth and, in addition, the optical density was determined by photometry. In this way, the minimum inhibitory concentrations (MHK) were determined for the two active substances individually and in combination.

The resulting synergism was represented numerically by calculating the synergy index (SI). The calculation was done by the customary method of F. C. Kull et al., Applied Microbiology, Vol. 9 (1961), p. 538. There, the SI is calculated by the following formula: synergy index SI =Qa/QA +Qb/QB

Qa =concentration of component A in the mixture A+B

QA =concentration of component A as sole biocide

Qb =concentration of component B in the mixture A+B

QB =concentration of component B as sole biocide

If the synergy index has a value over 1, this means that an antagonism is present. If the synergy index takes on the value 1, this means that an addition of the effect of the two biocides/compounds is present. If the synergy index takes on a value below 1, this means that a synergism exists for the two biocides. If the synergy index has a value of more than 1, this means that an antagonism exists.

### EXAMPLE 1a

### Examination of the Synergetic Interaction Between chloro-2-methyl-4-isothiazolin-3-one (CMIT) and 3-iodo-2-propynyl butylcarbamate (IPBC)

Calculation of the synergy index of chloro-2-methyl-4-isothiazolin-3-one (CMIT) and IPBC with regard to Pseudomonas putida at an incubation time of 48 hours at 30° C.

TABLE 1a

| | | Synergy index Qa/QA + |
|---|---|---|
| Qa (CIT) [ppm] | Qb (IPBC) [ppm] | Qb/QB |
| 0 | 1000 | 1.00 |
| 0.25 | 750 | 0.88 |
| 0.5 | 500 | 0.75 |
| 0.75 | 300 | 0.68 |
| 1 | 200 | 0.70 |
| 1.5 | 100 | 0.85 |
| 2 | 0 | 1.00 |

Qa: Concentration of CMIT in the mixture indicating an end point
QA: Concentration of CMIT as sole agent indicating an end point
Qb: Concentration of IPBC in the mixture indicating an end point
QB: Concentration of IPBC as sole agent indicating an end point

It is evident from Table 1a that the optimal synergism, i.e. the lowest synergy index (0.68) of a biocidal composition of CMIT and IPBC lies at a ratio of 0.75 ppm CMIT to 300 ppm IPBC. A synergism can be demonstrated if the weight ratio of the biocides CMIT and IPBC lies in the range of 1:67 to 1:3,000.

### Example 1b

### Examination of the Synergetic Interaction Between chloro-2-methyl-4-isothiazolin-3-one (CMIT) and 3-iodo-2-propynyl butylcarbamate (IPBC)

Calculation of the synergy index of chloro-2-methyl-4-isothiazolin-3-one (CMIT) and IPBC with regard to Yarrowia lipolytica at an incubation time of 48 hours at 25° C.

TABLE 1b

| Qa (CIT) | Qb (IPBC) | Synergy index |
|---|---|---|
| [ppm] | [ppm] | Qa/QA + Qb/QB |
| 0.00 | 2.50 | 1.00 |
| 0.50 | 1.75 | 0.90 |
| 0.75 | 1.25 | 0.80 |
| 0.75 | 1.00 | 0.70 |
| 0.75 | 0.75 | 0.60 |
| 1.00 | 0.75 | 0.70 |
| 1.50 | 0.50 | 0.80 |
| 2.50 | 0.00 | 1.00 |

Qa: Concentration of CMIT in the mixture indicating an end point
QA: Concentration of CMIT as sole agent indicating an end point
Qb: Concentration of IPBC in the mixture indicating an end point
QB: Concentration of IPBC as sole agent indicating an end point

It is evident from Table 1b that the optimal synergism, i.e. the lowest synergy index (0.60) of a biocidal composition of CMIT and IPBC lies at a ratio of 0.75 ppm CMIT to 0.75 ppm IPBC. A synergism can be demonstrated if the weight ratio of the biocides CMIT and IPBC lies in the range of 3:1 to 1:3.5.

### EXAMPLE 2a

### Examination of the Synergetic Interaction Between chloro-2-methyl-4-isothiazolin-3-one (CMIT) and octylisothiazolinone (OIT)

Calculation of the synergy index of chloro-2-methyl-4-isothiazolin-3-one (CMIT) and octylisothiazolinone (OIT) with regard to Pseudomonas putida at an incubation time of 48 hours at 30° C.

TABLE 2a

| Qa (CIT) | | Synergy index |
|---|---|---|
| [ppm] | Qb (OIT) [ppm] | Qa/QA + Qb/QB |
| 0 | 300 | 1.00 |
| 0.25 | 200 | 0.79 |
| 0.5 | 150 | 0.75 |
| 0.75 | 100 | 0.71 |
| 1 | 100 | 0.83 |
| 1.5 | 50 | 0.92 |
| 2 | 0 | 1.00 |

Qa: Concentration of CMIT in the mixture indicating an end point
QA: Concentration of CMIT as sole agent indicating an end point
Qb: Concentration of OIT in the mixture indicating an end point
QB: Concentration of OIT as sole agent indicating an end point

It is evident from Table 2a that the optimal synergism, i.e. the lowest synergy index (0.71) of a biocidal composition of CMIT and OIT, lies at a ratio of 0.75 ppm CMIT to 100 ppm OIT. A synergism can be demonstrated if the weight ratio of the biocides CMIT and OIT lies in the range of 1:33 to 1:800.

### EXAMPLE 2b

### Examination of the Synergetic Interaction Between chloro-2-methyl-4-isothiazolin-3-one (CMIT) and octylisothiazolinone (OIT)

Calculation of the synergy index of chloro-2-methyl-4-isothiazolin-3-one (CMIT) and octylisothiazolinone (OIT) with regard to Yarrowia lipolytica at an incubation time of 48 hours at 25° C.

TABLE 2b

| Qa (CIT) | Qb (OIT) | Synergy index |
|---|---|---|
| [ppm] | [ppm] | Qa/QA + Qb/QB |
| 0.00 | 2.00 | 1.00 |
| 0.25 | 1.50 | 0.85 |
| 0.50 | 1.00 | 0.70 |
| 0.75 | 1.00 | 0.80 |
| 0.75 | 0.75 | 0.68 |
| 1.00 | 0.50 | 0.65 |
| 1.50 | 0.25 | 0.73 |
| 2.00 | 0.25 | 0.93 |
| 2.50 | 0.00 | 1.00 |

Qa: Concentration of CMIT in the mixture indicating an end point
QA: Concentration of CMIT as sole agent indicating an end point
Qb: Concentration of OIT in the mixture indicating an end point
QB: Concentration of OIT as sole agent indicating an end point

It is evident from Table 2b that the optimal synergism, i.e. the lowest synergy index (0.65) of a biocidal composition of CMIT and OIT lies at a ratio of 1 ppm CMIT to 0.5 ppm OIT. A synergism can be demonstrated if the weight ratio of the biocides CMIT and OIT lies in the range of 8:1 to 1:6.

### EXAMPLE 3a

### Examination of the Synergetic Interaction Between chloro-2-methyl-4-isothiazolin-3-one (CMIT) and N-butyl-benzisothiazolinone (BBIT)

Calculation of the synergy index of chloro-2-methyl-4-isothiazolin-3-one (CMIT) and N-butyl-benzisothiazolinone (BBIT) with regard to Pseudomonas putida at an incubation time of 48 hours at 30° C.

TABLE 3a

| Qa (CIT) | | Synergy index |
|---|---|---|
| [ppm] | Qb (BBIT) [ppm] | Qa/QA + Qb/QB |
| 0 | 20 | 1.00 |
| 0.25 | 15 | 0.88 |
| 0.25 | 10 | 0.63 |
| 0.5 | 7.5 | 0.63 |
| 0.75 | 5 | 0.63 |
| 0.75 | 3 | 0.53 |
| 1 | 3 | 0.65 |
| 1.5 | 1 | 0.80 |
| 2 | 0 | 1.00 |

Qa: Concentration of CMIT in the mixture indicating an end point
QA: Concentration of CMIT as sole agent indicating an end point
Qb: Concentration of BBIT in the mixture indicating an end point
QB: Concentration of BBIT as sole agent indicating an end point

It is evident from Table 3a that the optimal synergism, i.e. the lowest synergy index (0.53) of a biocidal composition of CMIT and BBIT lies at a ratio of 0,75 ppm CMIT to 3 ppm BBIT. A synergism can be demonstrated if the weight ratio of the biocides CMIT and BBIT lies in the range of 1:0.67 to 1:60.

### EXAMPLE 3b

### Examination of the Synergetic Interaction Between chloro-2-methyl-4-isothiazolin-3-one (CMIT) and N-butyl-benzisothiazolinone (BBIT)

Calculation of the synergy index of chloro-2-methyl-4-isothiazolin-3-one (CMIT) and N-butyl-benzisothiazolinone (BBIT) with regard to Yarrowia lipolytica at an incubation time of 48 hours at 25° C.

TABLE 3b

| Qa (CIT) | Qb (BBIT) | Synergy index |
|---|---|---|
| [ppm] | [ppm] | Qa/QA + Qb/QB |
| 0.00 | 3.00 | 1.00 |
| 0.50 | 2.00 | 0.87 |
| 0.50 | 1.50 | 0.70 |
| 0.75 | 1.00 | 0.63 |
| 1.00 | 0.75 | 0.65 |
| 1.50 | 0.50 | 0.77 |
| 2.50 | 0.00 | 1.00 |

Qa: Concentration of CMIT in the mixture indicating an end point
QA: Concentration of CMIT as sole agent indicating an end point
Qb: Concentration of BBIT in the mixture indicating an end point
QB: Concentration of BBIT as sole agent indicating an end point

It is evident from Table 3b that the optimal synergism, i.e. the lowest synergy index (0.63) of a biocidal composition of CMIT and BBIT lies at a ratio of 0.75 ppm CMIT to 1 ppm BBIT. A synergism can be demonstrated if the weight ratio of the biocides CMIT and BBIT lies in the range of 3:1 to 1:4.

### EXAMPLE 4

### Examination of the Synergetic Interaction Between chloro-2-methyl-4-isothiazolin-3-one (CMIT) and Phenetyl Alcohol

Calculation of the synergy index of chloro-2-methyl-4-isothiazolin-3-one (CMIT) and 2,2-phenetyl alcohol with regard to Pseudomonas putida at an incubation time of 48 hours at 30° C.

TABLE 4

| Qa (CMIT) | Qb (phenetyl alcohol) | Synergy index |
|---|---|---|
| [ppm] | [ppm] | Qa/QA + Qb/QB |
| 0 | 3000 | 1.00 |
| 0.5 | 2000 | 0.92 |
| 0.75 | 1000 | 0.71 |
| 0.75 | 750 | 0.63 |
| 0.75 | 500 | 0.54 |
| 1 | 500 | 0.67 |
| 1.5 | 250 | 0.83 |
| 2 | 0 | 1.00 |

Qa: Concentration of CMIT in the mixture indicating an end point
QA: Concentration of CMIT as sole agent indicating an end point
Qb: Concentration of phenetyl alcohol in the mixture indicating an end point
QB: Concentration of phenetyl alcohol as sole agent indicating an end point

It is evident from Table 4 that the optimal synergism, i.e. the lowest synergy index (0.54) of a biocidal composition of CMIT and phenetyl alcohol, lies at a ratio of 0.75 ppm CMIT to 500 ppm phenetyl alcohol. A synergism can be demonstrated if the weight ratio of the biocides CMIT and phenetyl alcohol lies in the range of 1:167 to 1:4,000.

### EXAMPLE 5

### Examination of the Synergetic Interaction Between chloro-2-methyl-4-isothiazolin-3-one (CMIT) and Methylparaben

Calculation of the synergy index of chloro-2-methyl-4-isothiazolin-3-one (CMIT) and methylparaben with regard to Pseudomonas putida at an incubation time of 48 hours at 30° C.

TABLE 5

| Qa (CMIT) | Qb (methylparaben) | Synergy index Qa/QA + |
|---|---|---|
| [ppm] | [ppm] | Qb/QB |
| 0 | 2000 | 1.00 |
| 1 | 750 | 0.88 |
| 1 | 500 | 0.75 |
| 2 | 250 | 0.88 |
| 2 | 0 | 1.00 |

Qa: Concentration of CMIT in the mixture indicating an end point
QA: Concentration of CMIT as sole agent indicating an end point
Qb: Concentration of methylparaben in the mixture indicating an end point
QB: Concentration of methylparaben as sole agent indicating an end point

It is evident from Table 5 that the optimal synergism, i.e. the lowest synergy index (0.75) of a biocidal composition of CMIT and methylparaben lies at a ratio of 1 ppm CMIT to 500 ppm methylparaben. A synergism can be demonstrated if the weight ratio of the biocides CMIT and methylparaben lies in the range of 1:125 to 1:750.

### EXAMPLE 6

### Examination of the Synergetic Interaction Between chloro-2-methyl-4-isothiazolin-3-one (CMIT) and Ethylparaben

Calculation of the synergy index of chloro-2-methyl-4-isothiazolin-3-one (CMIT) and ethylparaben with regard to Pseudomonas putida at an incubation time of 48 hours at 30° C.

TABLE 6

| Qa (CMIT) | Qb (ethylparaben) | Synergy index |
|---|---|---|
| [ppm] | [ppm] | Qa/QA + Qb/QB |
| 0 | 1500 | 1.00 |
| 0.5 | 1000 | 0.92 |
| 0.5 | 750 | 0.75 |
| 0.75 | 500 | 0.71 |
| 0.75 | 250 | 0.54 |
| 1 | 125 | 0.58 |
| 1.5 | 125 | 0.83 |
| 2 | 0 | 1.00 |

Qa: Concentration of CMIT in the mixture indicating an end point
QA: Concentration of CMIT as sole agent indicating an end point
Qb: Concentration of ethylparaben in the mixture indicating an end point
QB: Concentration of ethylparaben as sole agent indicating an end point

It is evident from Table 6 that the optimal synergism, i.e. the lowest synergy index (0.54) of a biocidal composition of CMIT and ethylparaben lies at a ratio of 0.75 ppm CMIT to 250 ppm ethylparaben. A synergism can be demonstrated if the weight ratio of the biocides CMIT and ethylparaben lies in the range of 1:83 to 1:2,000.

### EXAMPLE 7

### Examination of the Synergetic Interaction Between chloro-2-methyl-4-isothiazolin-3-one (CMIT) and Benzoic Acid

Calculation of the synergy index of chloro-2-methyl-4-isothiazolin-3-one (CMIT) and benzoic acid with regard to Yarrowia lipolytica at an incubation time of 48 hours at 25° C.

TABLE 7

| Qa (CMIT) | Qb (benzoic acid) | Synergy index |
|---|---|---|
| [ppm] | [ppm] | Qa/QA + Qb/QB |
| 0 | 2500 | 1.00 |
| 0.5 | 1000 | 0.60 |
| 0.75 | 750 | 0.60 |
| 0.75 | 500 | 0.50 |
| 1 | 500 | 0.60 |
| 1 | 250 | 0.50 |
| 1.5 | 250 | 0.70 |
| 2.5 | 0 | 1.00 |

Qa: Concentration of CMIT in the mixture indicating an end point
QA: Concentration of CMIT as sole agent indicating an end point
Qb: Concentration of benzoic acid in the mixture indicating an end point
QB: Concentration of benzoic acid as sole agent indicating an end point

It is evident from Table 7 that the optimal synergism, i.e. the lowest synergy index (0.50) of a biocidal composition of CMIT and benzoic acid lies at a ratio of 1 ppm CMIT to 250 ppm benzoic acid. A synergism can be demonstrated if the weight ratio of the biocides CMIT and benzoic acid lies in the range of 1:167 to 1:2,000.

### EXAMPLE 8

### Examination of the Synergetic Interaction Between chloro-2-methyl-4-isothiazolin-3-one (CMIT) and Sorbic Acid

Calculation of the synergy index of chloro-2-methyl-4-isothiazolin-3-one (CMIT) and sorbic acid with regard to Yarrowia lipolytica at an incubation time of 48 hours at 25° C.

TABLE 8

| Qa (CMIT) | Qb (sorbic acid) | Synergy index |
|---|---|---|
| [ppm] | [ppm] | Qa/QA + Qb/QB |
| 0 | 750 | 1.00 |
| 0.25 | 500 | 0.77 |
| 0.5 | 500 | 0.87 |
| 0.75 | 250 | 0.63 |
| 1 | 125 | 0.57 |
| 1.5 | 125 | 0.77 |
| 2 | 125 | 0.97 |
| 2.5 | 0 | 1.00 |

Qa: Concentration of CMIT in the mixture indicating an end point
QA: Concentration of CMIT as sole agent indicating an end point
Qb: Concentration of sorbic acid in the mixture indicating an end point
QB: Concentration of sorbic acid as sole agent indicating an end point

It is evident from Table 8 that the optimal synergism, i.e. the lowest synergy index (0.57) of a biocidal composition of CMIT and sorbic acid lies at a ratio of 1 ppm CMIT to 125 ppm sorbic acid. A synergism can be demonstrated if the weight ratio of the biocides CMIT and sorbic acid lies in the range of 1:63 to 1:2,000.

### EXAMPLE 9

### Examination of the Synergetic Interaction Between chloro-2-methyl-4-isothiazolin-3-one (CMIT) and Salicylic Acid

Calculation of the synergy index of chloro-2-methyl-4-isothiazolin-3-one (CMIT) and salicylic acid with regard to Yarrowia lipolytica at an incubation time of 48 hours at 25° C.

TABLE 9

| Qa (CMIT) | Qb (salicylic acid) | Synergy index |
|---|---|---|
| [ppm] | [ppm] | Qa/QA + Qb/QB |
| 0 | 3000 | 1.00 |
| 0.5 | 2000 | 0.87 |
| 0.5 | 1000 | 0.53 |
| 0.75 | 750 | 0.55 |
| 0.75 | 500 | 0.47 |
| 1 | 500 | 0.57 |
| 1.5 | 500 | 0.77 |
| 2 | 250 | 0.88 |
| 2 | 125 | 0.84 |
| 2.5 | 0 | 1.00 |

Qa: Concentration of CMIT in the mixture indicating an end point
QA: Concentration of CMIT as sole agent indicating an end point
Qb: Concentration of salicylic acid in the mixture indicating an end point
QB: Concentration of salicylic acid as sole agent indicating an end point

It is evident from Table 9 that the optimal synergism, i.e. the lowest synergy index (0.47) of a biocidal composition of CMIT and salicylic acid lies at a ratio of 0.75 ppm CMIT to 500 ppm salicylic acid. A synergism can be demonstrated if the weight ratio of the components CMIT and salicylic acid lies in the range of 1:63 to 1:4,000.

### EXAMPLE 13

### Examination of the Synergetic Interaction Between chloro-2-methyl-4-isothiazolin-3-one (CMIT) and Dehydracetic Acid

Calculation of the synergy index of chloro-2-methyl-4-isothiazolin-3-one (CMIT) and dehydracetic acid with regard to Yarrowia lipolytica at an incubation time of 48 hours at 25° C.

TABLE 13

| Qa (CMIT) | Qb (dehydracetic acid) | Synergy index |
|---|---|---|
| [ppm] | [ppm] | Qa/QA + Qb/QB |
| 0 | 200 | 1.00 |
| 0.25 | 150 | 0.85 |
| 0.5 | 150 | 0.95 |
| 0.75 | 100 | 0.80 |
| 1 | 100 | 0.90 |
| 1.5 | 50 | 0.85 |
| 2.5 | 0 | 1.00 |

Qa: Concentration of CMIT in the mixture indicating an end point
QA: Concentration of CMIT as sole agent indicating an end point
Qb: Concentration of dehydracetic acid in the mixture indicating an end point
QB: Concentration of dehydracetic acid as sole agent indicating an end point

It is evident from Table 7 that the optimal synergism, i.e. the lowest synergy index (0.80) of a biocidal composition of CMIT and dehydracetic acid lies at a ratio of 0.75 ppm CMIT to 100 ppm dehydracetic acid. A synergism can be demonstrated if the weight ratio of the components CMIT and dehydracetic acid lies in the range of 1:33 to 1:600.

### EXAMPLE 10

### Examination of the Synergetic Interaction Between chloro-2-methyl-4-isothiazolin-3-one (CMIT) and Didecyldimethylammonium Chloride (DDAC)

Calculation of the synergy index of chloro-2-methyl-4-isothiazolin-3-one (CMIT) and didecyldimethylammonium chloride (DDAC) with regard to Pseudomonas putida at an incubation time of 48 hours at 30° C.

TABLE 10

| Qa (CMIT) | Qb (DDAC) | Synergy index |
|---|---|---|
| [ppm] | [ppm] | Qa/QA + Qb/QB |
| 0 | 7.5 | 1.00 |
| 0.25 | 5 | 0.79 |
| 0.5 | 5 | 0.92 |
| 1 | 2.5 | 0.83 |
| 1 | 1 | 0.63 |
| 1.5 | 0.5 | 0.82 |
| 2 | 0 | 1.00 |

Qa: Concentration of CMIT in the mixture indicating an end point
QA: Concentration of CMIT as sole agent indicating an end point
Qb: Concentration of DDAC in the mixture indicating an end point
QB: Concentration of DDAC as sole agent indicating an end point

It is evident from Table 10 that the optimal synergism, i.e. the lowest synergy index (0.63) of a biocidal composition of CMIT and DDAC lies at a ratio of 1 ppm CMIT to 1 ppm DDAC. A synergism can be demonstrated if the weight ratio of the components CMIT and DDAC lies in the range of 3:1 to 1:20.

### EXAMPLE 11

### Examination of the Synergetic Interaction Between chloro-2-methyl-4-isothiazolin-3-one (CMIT) and Benzalkonium Chloride (BAC)

Calculation of the synergy index of chloro-2-methyl-4-isothiazolin-3-one (CMIT) and benzalkonium chloride (BAC) with regard to Pseudomonas putida at an incubation time of 48 hours at 30° C.

TABLE 11

| Qa (CMIT) | Qb (BAC) | Synergy index |
|---|---|---|
| [ppm] | [ppm] | Qa/QA + Qb/QB |
| 0 | 30 | 1.00 |
| 0.5 | 20 | 0.92 |
| 0.75 | 15 | 0.88 |
| 1 | 10 | 0.83 |
| 1 | 7.5 | 0.75 |
| 1.5 | 5 | 0.92 |
| 2 | 0 | 1.00 |

Qa: Concentration of CMIT in the mixture indicating an end point
QA: Concentration of CMIT as sole agent indicating an end point
Qb: Concentration of BAC in the mixture indicating an end point
QB: Concentration of BAC as sole agent indicating an end point

It is evident from Table 11 that the optimal synergism, i.e. the lowest synergy index (0.75) of a biocidal composition of CMIT and BAC lies at a ratio of 1 ppm CMIT to 7.5 ppm BAC. A synergism can be demonstrated if the weight ratio of the components CMIT and BAC lies in the range of 1:3 to 1:40.

### EXAMPLE 12

### Examination of the Synergetic Interaction Between chloro-2-methyl-4-isothiazolin-3-one (CMIT) and Formaldehyde (HCHO)

Calculation of the synergy index of chloro-2-methyl-4-isothiazolin-3-one (CMIT) and formaldehyde (HCHO) with regard to Pseudomonas putida at an incubation time of 48 hours at 30° C.

TABLE 12

| Qa (CMIT) | Qb (HCHO) | Synergy index |
|---|---|---|
| [ppm] | [ppm] | Qa/QA + Qb/QB |
| 0 | 500 | 1.00 |
| 0.25 | 250 | 0.63 |
| 0.5 | 125 | 0.50 |
| 0.75 | 62.5 | 0.50 |
| 0.75 | 31.25 | 0.44 |
| 1 | 31.25 | 0.56 |
| 1.5 | 15.63 | 0.78 |
| 2 | 0 | 1.00 |

Qa: Concentration of CMIT in the mixture indicating an end point
QA: Concentration of CMIT as sole agent indicating an end point
Qb: Concentration of HCHO in the mixture indicating an end point
QB: Concentration of HCHO as sole agent indicating an end point

It is evident from Table 12 that the optimal synergism, i.e. the lowest synergy index (0.44) of a biocidal composition of CMIT and HCHO lies at a ratio of 0.75 ppm CMIT to 62.5 ppm HCHO. A synergism can be demonstrated if the weight ratio of the components CMIT and HCHO lies in the range of 1:10 to 1:1,000.

### EXAMPLE 13

### Examination of the Synergetic Interaction Between chloro-2-methyl-4-isothiazolin-3-one (CMIT) and Glutardialdehyde (GDA)

Calculation of the synergy index of chloro-2-methyl-4-isothiazolin-3-one (CMIT) and glutardialdehyde (GDA) with regard to Pseudomonas putida at an incubation time of 48 hours at 30° C.

TABLE 13

| Qa (CMIT) | Qb (GDA) | Synergy index |
|---|---|---|
| [ppm] | [ppm] | Qa/QA + Qb/QB |
| 0 | 500 | 1.00 |
| 0.5 | 250 | 0.75 |
| 0.5 | 125 | 0.50 |
| 0.5 | 62.5 | 0.38 |
| 1 | 62.5 | 0.63 |
| 1.5 | 31.25 | 0.81 |
| 2 | 0 | 1.00 |

Qa: Concentration of CMIT in the mixture indicating an end point
QA: Concentration of CMIT as sole agent indicating an end point
Qb: Concentration of GDA in the mixture indicating an end point
QB: Concentration of GDA as sole agent indicating an end point

It is evident from Table 13 that the optimal synergism, i.e. the lowest synergy index (0.38) of a biocidal composition of CMIT and GDA lies at a ratio of 1 ppm CMIT to 125 ppm GDA. A synergism can be demonstrated if the weight ratio of the components CMIT and GDA lies in the range of 1:21 to 1:500.

### EXAMPLE 14

### Examination of the Synergetic Interaction Between chloro-2-methyl-4-isothiazolin-3-one (CMIT) and (1-hydroxyethylidene)bis-phosphonic Acid (HEDP)

Calculation of the synergy index of chloro-2-methyl-4-isothiazolin-3-one (CMIT) and (1-hydroxyethylidene)bis-phosphonic acid (HEDP) with regard to Pseudomonas putida at an incubation time of 48 hours at 30° C.

TABLE 14

| Qa (CMIT) | Qb (HEDP) | Synergy index |
|---|---|---|
| [ppm] | [ppm] | Qa/QA + Qb/QB |
| 0 | 250 | 1.00 |
| 0.25 | 125 | 0.63 |
| 0.5 | 31.25 | 0.38 |
| 0.75 | 31.25 | 0.50 |
| 1 | 15.63 | 0.56 |
| 1.5 | 16.63 | 0.82 |
| 2 | 0 | 1.00 |

Qa: Concentration of CMIT in the mixture indicating an end point
QA: Concentration of CMIT as sole agent indicating an end point
Qb: Concentration of HEDP in the mixture indicating an end point
QB: Concentration of HEDP as sole agent indicating an end point

It is evident from Table 14 that the optimal synergism, i.e. the lowest synergy index (0.38) of a biocidal composition of CMIT and HEDP lies at a ratio of 0.5 ppm CMIT to 31.25 ppm HEDP. A synergism can be demonstrated if the weight ratio of the components CMIT and HEDP lies in the range of 1:11 to 1:500.

### EXAMPLE 15

### Examination of the Synergetic Interaction Between chloro-2-methyl-4-isothiazolin-3-one (CMIT) and Ethylenediamine Disuccinate (EDDS)

Calculation of the synergy index of chloro-2-methyl-4-isothiazolin-3-one (CMIT) and ethylenediamine disuccinate (EDDS) with regard to Pseudomonas putida at an incubation time of 48 hours at 30° C.

TABLE 15

| Qa (CMIT) | Qb (EDDS) | Synergy index |
|---|---|---|
| [ppm] | [ppm] | Qa/QA + Qb/QB |
| 0 | 5000 | 1.00 |
| 0.25 | 2500 | 0.63 |
| 0.5 | 1250 | 0.50 |
| 0.75 | 312.5 | 0.44 |
| 0.75 | 156.25 | 0.41 |
| 1 | 156.25 | 0.53 |
| 1.5 | 156.25 | 0.78 |
| 2 | 0 | 1.00 |

Qa: Concentration of CMIT in the mixture indicating an end point
QA: Concentration of CMIT as sole agent indicating an end point
Qb: Concentration of EDDS in the mixture indicating an end point
QB: Concentration of EDDS as sole agent indicating an end point

It is evident from Table 15 that the optimal synergism, i.e. the lowest synergy index (0.41) of a biocidal composition of CMIT and EDDS lies at a ratio of 0.75 ppm CMIT to 156.25 ppm EDDS. A synergism can be demonstrated if the weight ratio of the components CMIT and EDDS lies in the range of 1:104 to 1:10,000.

### EXAMPLE 16

### Examination of the Synergetic Interaction Between chloro-2-methyl-4-isothiazolin-3-one (CMIT) and Polyaspartic Acid (PASP)

Calculation of the synergy index of chloro-2-methyl-4-isothiazolin-3-one (CMIT) and polyaspartic acid Na salt (PASP Na salt)with regard to Pseudomonas putida at an incubation time of 48 hours at 30° C.

TABLE 16

| Qa (CMIT) | Qb (PASP Na salt) | Synergy index |
|---|---|---|
| [ppm] | [ppm] | Qa/QA + Qb/QB |
| 0 | 10000 | 1.00 |
| 0.75 | 5000 | 0.88 |
| 1 | 2500 | 0.75 |
| 1 | 1250 | 0.63 |
| 1 | 625 | 0.56 |
| 1.5 | 312.5 | 0.78 |
| 2 | 0 | 1.00 |

Qa: Concentration of CMIT in the mixture indicating an end point
QA: Concentration of CMIT as sole agent indicating an end point
Qb: Concentration of PASP Na salt in the mixture indicating an end point
QB: Concentration of PASP Na salt as sole agent indicating an end point

It is evident from Table 16 that the optimal synergism, i.e. the lowest synergy index (0.56) of a biocidal composition of CMIT and PASP Na salt lies at a ratio of 1 ppm CMIT to 625 ppm PASP Na salt. A synergism can be demonstrated if the weight ratio of the components CMIT and PASP Na salt lies in the range of 1:208 to 1:6,667.

1. A biocidal composition containing 5-chloro-2-methylisothiazolin-3-one and at least one further component chosen from the group of 3-iodo-2-propynyl butylcarbamate, octylisothiazolinone, N-butyl-benzisothiazolinone, phenetyl alcohol, methylparaben, ethylparaben, benzoic acid, sorbic acid or salts thereof, salicylic acid or salts thereof, dehydracetic acid or salts thereof, didecyldimethylammonium chloride, benzalkonium chloride, formaldehyde, glutardialdehyde, (1-hydroxyethylidene)bis-phosphonic acid, ethylenediamine disuccinate, polyaspartic acid,
characterized in that the composition contains methyl-4-isothiazolin-3-one in the range of 0 to 2 wt. %, in relation to the total amount of the 5-chloro-2-methyl-4-isothiazolin-3-one.

2. The biocidal composition according to claim 1, characterized in that the weight ratio of 5-chloro-2-methylisothiazolin-3-one to 3-iodo-2-propynyl butylcarbamate lies in the range of 3:1 to 1:3,000,
in that the weight ratio of 5-chloro-2-methylisothiazolin-3-one to octylisothiazolinone lies in the range of 8:1 to 1:800,
in that the weight ratio of 5-chloro-2-methylisothiazolin-3-one to N-butyl-benzisothiazolinone lies in the range of 3:1 to 1:60,
in that the weight ratio of 5-chloro-2-methylisothiazolin-3-one to phenetyl alcohol lies in the range of 1:167 to 1:4,000,
in that the weight ratio of 5-chloro-2-methylisothiazolin-3-one to 2,2-methylparaben lies in the range of 1:125 to 1:750,
in that the weight ratio of 5-chloro-2-methylisothiazolin-3-one to ethylparaben lies in the range of 1:83 to 1:2,000,
in that the weight ratio of 5-chloro-2-methylisothiazolin-3-one to benzoic acid lies in the range of 1:167 to 1:2,000,
in that the weight ratio of 5-chloro-2-methylisothiazolin-3-one to sorbic acid lies in the range of 1:63 to 1:2,000,
in that the weight ratio of 5-chloro-2-methylisothiazolin-3-one to salicylic acid lies in the range of 1:63 to 1:4,000,
in that the weight ratio of 5-chloro-2-methylisothiazolin-3-one to dehydracetic acid lies in the range of 1:33 to 1:600,
in that the weight ratio of 5-chloro-2-methylisothiazolin-3-one to didecyldimethylammonium chloride lies in the range of 3:1 to 1:20,
in that the weight ratio of 5-chloro-2-methylisothiazolin-3-one to benzalkonium chloride lies in the range of 1:3 to 1:40,
in that the weight ratio of 5-chloro-2-methylisothiazolin-3-one to formaldehyde lies in the range of 1:10 to 1:1,000,
in that the weight ratio of 5-chloro-2-methylisothiazolin-3-one to glutardialdehyde lies in the range of 1:21 to 1:500,
in that the weight ratio of 5-chloro-2-methylisothiazolin-3-one to (1-hydroxyethylidene)bis-phosphonic acid lies in the range of 1:11 to 1:500,
in that the weight ratio of 5-chloro-2-methylisothiazolin-3-one to ethylenediamine disuccinate lies in the range of 1:104 to 1:10,000, and
in that the weight ratio of 5-chloro-2-methylisothiazolin-3-one to polyaspartic acid (as Na salt) lies in the range of 1:208 to 1:6,667.

3. The biocidal composition according to claim 1, characterized in that it contains the 5-chloro-2-methylisothiazolin-3-one and the at least one further biocide in a total concentration of 0.5 to 50 wt. %, in relation to the total biocide composition.

4. The biocidal composition according to claim 1, characterized in that it comprises a polar and a nonpolar medium.

5. The biocidal composition according to claim 4, characterized in that it comprises, as polar liquid medium, water, an aliphatic alcohol with 1 to 4 carbon atoms, a glycol, a glycol ether, a glycol ester, a polyethylene glycol, a propylene glycol, N,N-dimethylformamide, 2,2,4-trimethylpentandiolmonoisobutyrate or a mixture thereof.

6. The biocidal composition according to claim 1, characterized in that it is present in the form of a liquid preparation.

7. Use of the biocidal composition according claim 1 for in-can preservation.

8. The use of the biocidal composition according to claim 7 for the in-can preservation of coating materials such as paints, varnishes and plaster, of polymer dispersions, emulsions, latexes and adhesives.

9. A preserved product, containing a biocidal composition as described in claim 1.

10. The preserved product according to claim 9, selected from lignin sulfonates and starch preparations in coating materials, paints, varnishes, glazes and plasters, emulsions, latexes, polymer dispersions, chalk slurries, mineral slurries, ceramic materials, adhesives, fragrances, casein-containing products, starch-containing products, bitumen emulsions, surfactant solutions, fuels, cleaning agents, pigment pastes and pigment dispersions, inks, lithographic liquids, thickeners, cosmetic products, toilet articles, water systems, fluids in wood working, fluids in oil extraction, fluids in paper processing, fluids in leather production, fluids in textile production, drilling and cutting oils, hydraulic fluids and cooling lubricants.
